(19) United States
(12) Patent Application Publication
(10) Pub. No.: US 2026/0367271 A1
(43) Pub. Date: Nov. 19, 2026

(54) METHOD AND APPARATUS FOR CALCULATING SEISMIC COHERENCE CUBE, ELECTRONIC DEVICE, AND COMPUTER-READABLE STORAGE MEDIUM

(71) Applicant: Institute of Geology and Geophysics, Chinese Academy of Sciences, Beijing (CN)

(72) Inventors: Xuhui ZHOU, Beijing (CN); Shoudong HUO, Beijing (CN); Zhenghui GAO, Changchun (CN); Fuxing HAN, Changchun (CN); Zhimiao CHANG, Changchun (CN); Liang HUANG, Beijing (CN); Shengqiang MU, Beijing (CN); Jiangyun ZHANG, Beijing (CN); Wenchao SU, Beijing (CN); Mingran LIU, Beijing (CN)

(73) Assignee: Institute of Geology and Geophysics, Chinese Academy of Sciences, Beijing (CN)

(21) Appl. No.: 19/262,552

(22) Filed: Jul. 8, 2025

(30) Foreign Application Priority Data
May 19, 2025 (CN) 202510639984.6

(51) Int. Cl. G01V 1/34

(52) U.S. Cl. CPC G01V 1/345

(57) ABSTRACT

The present application provides a method and an apparatus for calculating a seismic coherence cube, an electronic device, and a computer-readable storage medium. The method includes: sequentially extracting three-dimensional sampling data cubes from a three-dimensional post-stack seismic data cube of a to-be-processed area according to a preset calculation window by using a single data sampling point as a center; determining a local event slope at a central position of each three-dimensional sampling data cube by using a direct search method; and determining a coherence value at the central position of each three-dimensional sampling data cube according to the local event slope at the central position of each three-dimensional sampling data cube and a coherence calculation formula that is based on a variational principle, to obtain a seismic coherence cube of the to-be-processed area.

### CROSS-REFERENCE TO RELATED APPLICATIONS

The application claims priority to Chinese patent application No. 2025106399846, filed on May 19, 2025, the entire contents of which are incorporated herein by reference.

### TECHNICAL FIELD

The present application relates to the technical field of geophysics, and in particular, to a method and an apparatus for calculating a seismic coherence cube, an electronic device, and a computer-readable storage medium.

### BACKGROUND

In the field of exploration seismology, the characterization of discontinuities is a key issue in seismic data interpretation. Especially when performing precise interpretation of faults, reservoirs, hydrocarbon migration processes, and the like, a discontinuity characterization tool with rapid and high-resolution characteristics will greatly improve the efficiency and accuracy of seismic interpretation. As a key seismic attribute, the coherence cube is currently one of the most important tools for discontinuity characterization. The calculation results of the coherence cube can not only be used for fault interpretation in exploration areas but also applied to monitor the quality of seismic data processing.

In the prior art, there are three main generations of calculation methods for the coherence cube. The first-generation coherence cube algorithm (hereinafter referred to as the C1 algorithm) is a coherence cube algorithm based on cross-correlation. This method calculates the cross-correlation between a selected central trace and two adjacent traces and uses the cross-correlation result to measure the coherence value. The second-generation coherence cube algorithm (hereinafter referred to as the C2 algorithm) is a coherence cube algorithm based on multi-trace semblance. This algorithm selects a standard trace, calculates the sum of least-squares errors between each seismic trace in the selected window and the standard trace, and uses the sum of errors to measure the coherence value. The third-generation coherence cube algorithm (hereinafter referred to as the C3 algorithm) is a coherence cube algorithm based on the eigenstructure. This algorithm measures the coherence value of the corresponding seismic data by calculating the maximum eigenvalue of the covariance matrix of seismic data within the specific window.

For the C1 algorithm, although the C1 algorithm performs well in high-quality data, the noise resistance of the C1 algorithm is relatively weak when facing seismic data with a low signal-to-noise ratio, and the C1 algorithm often fails to accurately distinguish discontinuities. For the C2 algorithm, when facing seismic data with significant lateral amplitude variations, the C2 algorithm may yield incorrect results, which will reduce resolution and may even lead to erroneous judgments in seismic interpretation. Although the C3 algorithm has higher resolution, the computational efficiency of the C3 algorithm is quite low. Typically, when facing the same data cube, the computational time of the C3 algorithm is ten times longer than that of the C2 algorithm, which limits the practical application of the C3 algorithm.

### SUMMARY

The present application provides a method and an apparatus for calculating a seismic coherence cube, an electronic device, and a computer-readable storage medium. The calculation method is improved based on a C2 algorithm, which can improve resolution on the basis of maintaining corresponding computational efficiency.

According to a first aspect, the present application discloses a method for calculating a seismic coherence cube, including:
sequentially extracting three-dimensional sampling data cubes from a three-dimensional post-stack seismic data cube of a to-be-processed area according to a preset calculation window by using a single data sampling point as a center;
determining a local event slope at a central position of each three-dimensional sampling data cube by using a direct search method; and
determining a coherence value at the central position of each three-dimensional sampling data cube according to the local event slope at the central position of each three-dimensional sampling data cube and a coherence calculation formula that is based on a variational principle, to obtain a seismic coherence cube of the to-be-processed area, where
the coherence calculation formula that is based on the variational principle is as follows:

$${C}_{v} ( t , {\hat{p}}_{x} , {\hat{p}}_{y} ) = \frac{\begin{matrix}{\sum }_{i = 1}^{M} {\sum }_{j = 1}^{N} [ u ( t + i Δ t - {\hat{p}}_{x} x - {\hat{p}}_{y} y , j ) - \\ {a ( j ) \overline{u} ( t + i Δ t - {\hat{p}}_{x} x - {\hat{p}}_{y} y ) ]}^{2}\end{matrix}}{{\sum }_{i = 1}^{M} {\sum }_{j = 1}^{N} {[ u ( t + i Δ t - {\hat{p}}_{x} x - {\hat{p}}_{y} y , j ) ]}^{2}} ;$$

and
in the formula: Cᵥ represents the coherence value based on the variational principle, u represents the three-dimensional sampling data cube, t represents sampling time at the central position of the three-dimensional sampling data cube, Δt is a time sampling interval, (\hat{p}ₓ,\hat{p}_{y}) represents the local event slope at the central position of the three-dimensional sampling data cube, M represents a quantity of time samples of the three-dimensional sampling data cube, i represents an index of a time sampling point, N represents a total quantity of traces of the three-dimensional sampling data cube, j represents an index of the quantity of traces, x and y represent space coordinates of a seismic trace corresponding to the central position of the three-dimensional sampling data cube, ū represents an average of all traces of the three-dimensional sampling data cube along a space direction,

$$\overline{u} ( i ) = \frac{1}{N} {\sum }_{j = 1}^{N} u ( i , j ) ,$$

a(j) represents an adaptive coefficient based on the variational principle, and

$$a ( j ) = \frac{{\sum }_{i}^{M} \overline{u} ( i ) u ( i , j )}{{\sum }_{i}^{M} {\overline{u}}^{2} ( i )} .$$

In a possible implementation, a process of determining a local event slope at a central position of each three-dimensional sampling data cube by using a direct search method includes:
determining a plurality of slope sampling points according to value ranges and sampling intervals of a preset local event slope in a first direction and a second direction;
calculating a coherence value corresponding to each slope sampling point at the central position of each three-dimensional sampling data cube by using a coherence calculation formula that is based on multi-trace semblance; and
selecting, at the central position of each three-dimensional sampling data cube, a local event slope of a slope sampling point corresponding to a minimum coherence value as the local event slope at the central position of each three-dimensional sampling data cube.

In a possible implementation, the calculation window is a sampling range that uses the single data sampling point as the center and that is formed by a preset quantity of seismic traces and a preset length of time sampling points that surround the single data sampling point.

In a possible implementation, a quantity of seismic traces in the calculation window is 3, 5, or 9.

According to a second aspect, the present application further discloses an apparatus for calculating a seismic coherence cube, including:
a data cube selection module, configured to sequentially extract three-dimensional sampling data cubes from a three-dimensional post-stack seismic data cube of a to-be-processed area according to a preset calculation window by using a single data sampling point as a center;
a slope calculation module, configured to determine a local event slope at a central position of each three-dimensional sampling data cube by using a direct search method; and
a coherence value calculation module, configured to determine a coherence value at the central position of each three-dimensional sampling data cube according to the local event slope at the central position of each three-dimensional sampling data cube and a coherence calculation formula that is based on a variational principle, to obtain a seismic coherence cube of the to-be-processed area, where
the coherence calculation formula that is based on the variational principle is as follows:

$${C}_{v} ( t , {\hat{p}}_{x} , {\hat{p}}_{y} ) = \frac{\begin{matrix}{\sum }_{i = 1}^{M} {\sum }_{j = 1}^{N} [ u ( t + i Δ t - {\hat{p}}_{x} x - {\hat{p}}_{y} y , j ) - \\ {a ( j ) \overline{u} ( t + i Δ t - {\hat{p}}_{x} x - {\hat{p}}_{y} y ) ]}^{2}\end{matrix}}{{\sum }_{i = 1}^{M} {\sum }_{j = 1}^{N} {[ u ( t + i Δ t - {\hat{p}}_{x} x - {\hat{p}}_{y} y , j ) ]}^{2}} ;$$

and
in the formula: Cᵥ represents the coherence value based on the variational principle, u represents the three-dimensional sampling data cube, t represents sampling time at the central position of the three-dimensional sampling data cube, Δt is a time sampling interval, (\hat{p}ₓ,\hat{p}_{y}) represents the local event slope at the central position of the three-dimensional sampling data cube, M represents a quantity of time samples of the three-dimensional sampling data cube, i represents an index of a time sampling point, N represents a total quantity of traces of the three-dimensional sampling data cube, j represents an index of the quantity of traces, x and y represent space coordinates of a seismic trace corresponding to the central position of the three-dimensional sampling data cube, ū represents an average of all traces of the three-dimensional sampling data cube along a space direction,

$$\overline{u} ( i ) = \frac{1}{N} {\sum }_{j = 1}^{N} u ( i , j ) ,$$

a(j) represents an adaptive coefficient based on the variational principle, and

$$a ( j ) = \frac{{\sum }_{i}^{M} \overline{u} ( i ) u ( i , j )}{{\sum }_{i}^{M} {\overline{u}}^{2} ( i )} .$$

In a possible implementation, the slope calculation module includes:
a slope sampling point determination unit, configured to determine a plurality of slope sampling points according to value ranges and sampling intervals of a preset local event slope in a first direction and a second direction;
a slope sampling point coherence value calculation unit, configured to calculate a coherence value corresponding to each slope sampling point at the central position of each three-dimensional sampling data cube by using a coherence calculation formula that is based on multi-trace semblance; and
a slope value determination unit, configured to select, at the central position of each three-dimensional sampling data cube, a local event slope of a slope sampling point corresponding to a minimum coherence value as the local event slope at the central position of each three-dimensional sampling data cube.

According to a third aspect, the present application further provides an electronic device, including: a memory and a processor, where
the memory stores a computer executable instruction; and
the processor executes the computer executable instruction stored in the memory, to enable the processor to execute various possible implementations according to the first aspect and/or the second aspect.

According to a fourth aspect, the present application further provides a computer-readable storage medium, where the computer-readable storage medium stores a computer executable instruction, and when executed by a processor, the computer executable instruction is used to implement various possible implementations according to the first aspect and/or the second aspect.

Embodiments of the present application provide a method and an apparatus for calculating a seismic coherence cube, a device, and a computer-readable storage medium. The method includes: sequentially extracting three-dimensional sampling data cubes from a three-dimensional post-stack seismic data cube of a to-be-processed area according to a preset calculation window by using a single data sampling point as a center; determining a local event slope at a central position of each three-dimensional sampling data cube by using a direct search method; and determining a coherence value at the central position of each three-dimensional sampling data cube according to the local event slope at the central position of each three-dimensional sampling data cube and a coherence calculation formula that is based on a variational principle, to obtain a seismic coherence cube of the to-be-processed area, where the coherence calculation formula is as follows:

$${C}_{v} ( t , {\hat{p}}_{x} , {\hat{p}}_{y} ) = \frac{\begin{matrix}{\sum }_{i = 1}^{M} {\sum }_{j = 1}^{N} [ u ( t + i Δ t - {\hat{p}}_{x} x - {\hat{p}}_{y} y , j ) - \\ {a ( j ) \overline{u} ( t + i Δ t - {\hat{p}}_{x} x - {\hat{p}}_{y} y ) ]}^{2}\end{matrix}}{{\sum }_{i = 1}^{M} {\sum }_{j = 1}^{N} {[ u ( t + i Δ t - {\hat{p}}_{x} x - {\hat{p}}_{y} y , j ) ]}^{2}} ;$$

and
in the formula: Cᵥ represents the coherence value based on the variational principle, u represents the three-dimensional sampling data cube, t represents sampling time at the central position of the three-dimensional sampling data cube, Δt is a time sampling interval, (\hat{p}ₓ,\hat{p}_{y}) represents the local event slope at the central position of the three-dimensional sampling data cube, M represents a quantity of time samples of the three-dimensional sampling data cube, i represents an index of a time sampling point, N represents a total quantity of traces of the three-dimensional sampling data cube, j represents an index of the quantity of traces, x and y represent space coordinates of a seismic trace corresponding to the central position of the three-dimensional sampling data cube, ū represents an average of all traces of the three-dimensional sampling data cube along a space direction,

$$\overline{u} ( i ) = \frac{1}{N} {\sum }_{j = 1}^{N} u ( i , j ) ,$$

a(j) represents an adaptive coefficient based on the variational principle, and

$$a ( j ) = \frac{{\sum }_{i}^{M} \overline{u} ( i ) u ( i , j )}{{\sum }_{i}^{M} {\overline{u}}^{2} ( i )} .$$

Since the present invention uses a coherence calculation formula that introduces an adaptive standard trace to calculate a coherence value of each three-dimensional sampling data cube, an impact of a lateral amplitude variation of seismic data on coherence value calculation is reduced. The method not only maintains a characteristic of high efficiency of a C2 algorithm but also has the characteristic of high resolution of a C3 algorithm, thereby significantly improving a distinguishing capability for faults, planes of unconformity, and other discontinuities.

### BRIEF DESCRIPTION OF THE DRAWINGS

The accompanying drawings herein are incorporated in the specification as a part of the specification, showing embodiments that are in accordance with the present application, and used together with the specification to explain a principle of the present application.

FIG. 1 is a schematic flowchart of a method for calculating a seismic coherence cube according to an embodiment of the present application;

FIG. 2 is a schematic diagram of a plurality of calculation windows according to an embodiment of the present application;

FIG. 3 is a comparison diagram of horizontal slices at a certain time position of a coherence cube calculated by using a C2 algorithm and a C3 algorithm respectively for a three-dimensional post-stack seismic data cube A according to an embodiment of the present application;

FIG. 4 is a comparison diagram of vertical slices at a certain space position of a coherence cube calculated by using a C2 algorithm and a C3 algorithm respectively for a three-dimensional post-stack seismic data cube A according to an embodiment of the present application;

FIG. 5 is a comparison diagram of horizontal slices at a certain time position of a coherence cube calculated by using a C2 algorithm and a C3 algorithm respectively for a three-dimensional post-stack seismic data cube B according to an embodiment of the present application;

FIG. 6 is a comparison diagram of vertical slices at a certain space position of a coherence cube calculated by using a C2 algorithm and a C3 algorithm respectively for a three-dimensional post-stack seismic data cube B according to an embodiment of the present application;

FIG. 7 is a schematic structural diagram of an apparatus for calculating a seismic coherence cube according to an embodiment of the present application; and

FIG. 8 is a schematic structural diagram of a device for calculating a seismic coherence cube according to an embodiment of the present application.

Through the above accompanying drawings, clear embodiments of the present application have been shown, which will be described in more detail in the following text. These accompanying drawings and textual descriptions are not intended to limit the scope of the inventive concept of the present application in any way, but rather to illustrate the concept of the present application for those skilled in the art by referring to specific embodiments.

### DETAILED DESCRIPTION OF THE EMBODIMENTS

Exemplary embodiments are described in detail herein, and examples of which are shown in the accompanying drawings. When the following description relates to the accompanying drawings, the same numbers in different accompanying drawings represent the same or similar elements unless otherwise indicated. The implementations described in the following exemplary embodiments do not represent all implementations consistent with the present application. Instead, the implementations are merely examples of apparatus and methods consistent with some aspects of the present application as detailed in the appended claims.

In an existing method for calculating a coherence cube, when facing seismic data with a significant lateral amplitude variation, a C2 algorithm may yield incorrect results, which reduce resolution and may even lead to erroneous judgments in seismic interpretation. Although a C3 algorithm has higher resolution, the computational efficiency of the C3 algorithm is low. Typically, when facing the same data cube, the computational time of the C3 algorithm is ten times longer than that of the C2 algorithm, which limits the practical application of the C3 algorithm.

The present application provides a method and an apparatus for calculating a seismic coherence cube, a device, and a computer-readable storage medium. Based on a variational principle, an adaptive standard trace is introduced to calculate a least-squares error between seismic data in a calculation window and the adaptive standard trace, which can eliminate an impact of a lateral amplitude variation of the seismic data on coherence cube calculation, thereby improving the C2 algorithm. The new method significantly improves a distinguishing capability for faults, planes of unconformity, and other discontinuities while maintaining computational efficiency of the C2 algorithm.

The following specific embodiments are used to describe in detail the technical solutions of the present application and how the technical solutions of the present application solve the above technical problems. The following specific embodiments can be combined with each other, and the same or similar concepts or processes may not be elaborated in some embodiments. The following will describe the embodiments of the present application in conjunction with the accompanying drawings.

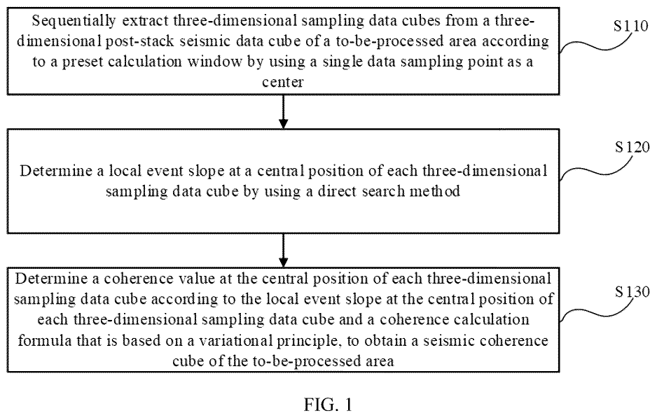

FIG. 1 is a schematic flowchart of a method for calculating a seismic coherence cube according to an embodiment of the present application. As shown in FIG. 1, the method for calculating a seismic coherence cube provided by the embodiment may include the following steps:

S110: sequentially extracting three-dimensional sampling data cubes from a three-dimensional post-stack seismic data cube of a to-be-processed area according to a preset calculation window by using a single data sampling point as a center.

In the embodiment of the present application, the to-be-processed area is a target area that requires a corresponding coherence cube. In the target area, a seismic data collection device needs to be used for data collection and then performs three-dimensional stack and migration processing on collected seismic data, to obtain the three-dimensional post-stack seismic data cube.

To obtain a seismic coherence cube according to the above three-dimensional post-stack seismic data cube, the three-dimensional post-stack seismic data cube needs to be divided into a series of three-dimensional sampling data cubes according to the preset calculation window by using the single data sampling point as the center, a coherence value at a central position of each three-dimensional sampling data cube is calculated, and finally, the seismic coherence cube corresponding to the three-dimensional post-stack seismic data cube of the to-be-processed area is obtained.

In the embodiment of the present invention, the preset calculation window is a sampling range that uses the single data sampling point as the center and that is formed by a preset quantity of seismic traces and a preset length of time sampling points that surround the single data sampling point.

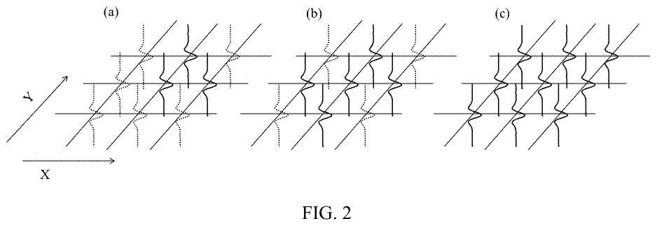

Exemplarily, a quantity of seismic traces in a calculation window of the single data sampling point may be as shown in FIG. 2. FIG. 2-(a), FIG. 2-(b), and FIG. 2-(c) are calculation windows including 3, 5, and 9 seismic traces respectively. In the figure, a solid curve line represents a selected seismic trace, and a dashed curve line represents an unselected seismic trace.

Specifically, the calculation window shown in FIG. 2-(a) is formed by a seismic trace where the sampling point is located and two surrounding seismic traces jointly; the calculation window shown in FIG. 2-(b) is formed by the seismic trace where the sampling point is located and four front, rear, left, and right seismic traces; and the calculation window shown in FIG. 2-(c) is formed by the seismic trace where the sampling point is located and eight surrounding seismic traces jointly.

It may be understood that when the three-dimensional sampling data cubes are selected from the three-dimensional post-stack seismic data cube, only the three-dimensional sampling data cube that can satisfy that there are enough data sampling points in the calculation window is selected. The three-dimensional sampling data cube includes a central point at the central position of the three-dimensional sampling data cube and all data sampling points in the calculation window centered on the central point. A part of data sampling points that are not suitable as the central points of the three-dimensional sampling data cube in the three-dimensional post-stack seismic data cube are not used as the central points, and the data sampling points that can be used as the central points in the three-dimensional post-stack seismic data cube are used as the central points and corresponding three-dimensional sampling data cubes are extracted.

In a time direction, a time sampling window in the calculation window is preferably in a range of 20 ms to 100 ms. Certainly, the time sampling window may be adjusted as required, which is not specifically limited herein. A quantity of sampling points in the time sampling window is guaranteed to be an odd number.

It needs to be noted that the three-dimensional sampling data cube extracted in the three-dimensional post-stack seismic data cube by using the data sampling point as the center is equivalent to a cuboid data space.

S120: determining a local event slope at a central position of each three-dimensional sampling data cube by using a direct search method.

In the embodiment of the present application, a process of determining a local event slope at a central position of each three-dimensional sampling data cube by using a direct search method may specifically include steps S121 to S123.

S121: determining a plurality of slope sampling points according to value ranges and sampling intervals of a preset local event slope in a first direction and a second direction.

For example, it is assumed that the value ranges of the local event slope in the first direction (X direction) and the second direction (Y direction) are both [−pₘₐₓ,pₘₐₓ], and the sampling intervals are both Δp. Exemplarily, pₘₐₓ is 0.1 ms/m, and Δp is 0.01 ms/m.

S122: calculating a coherence value corresponding to each slope sampling point at the central position of each three-dimensional sampling data cube by using a coherence calculation formula that is based on multi-trace semblance.

In the embodiment, for each slope sampling point (pₓ,p_{y}), the coherence calculation formula (that is, the C2 algorithm) based on multi-trace semblance used to calculate the coherence value corresponding to the slope sampling point is as follows:

$${C}_{2} ( t , {p}_{x} , {p}_{y} ) = \frac{\begin{matrix}{\sum }_{i = 1}^{M} {\sum }_{j = 1}^{N} [ u ( t + i Δ t - {p}_{x} x - {p}_{y} y , j ) - \\ {\frac{1}{N} {\sum }_{j = 1}^{N} u ( t + i Δ t - {p}_{x} x - {p}_{y} y , j ) ]}^{2}\end{matrix}}{{\sum }_{i = 1}^{M} {\sum }_{j = 1}^{N} {[ u ( t + i Δ t - {p}_{x} x - {p}_{y} y , j ) ]}^{2}} ;$$

and
in the formula, C2 represents the coherence value obtained through calculation by using the C2 algorithm, u represents the three-dimensional sampling data cube extracted in step S110, t represents sampling time at the central position of the three-dimensional sampling data cube, Δt is a time sampling interval, (pₓ,p_{y}) represents slope values along the X direction and the Y direction, M represents a quantity of time samples of the three-dimensional sampling data cube, i represents an index of a time sampling point, N represents a total quantity of traces of the three-dimensional sampling data cube, j represents an index of the quantity of traces, and x and y represent space coordinates of a seismic trace corresponding to the central position of the three-dimensional sampling data cube.

S123: selecting, at the central position of each three-dimensional sampling data cube, a local event slope of a slope sampling point corresponding to a minimum coherence value as the local event slope of each three-dimensional sampling data cube.

In the embodiment, for any three-dimensional sampling data cube, the coherence value corresponding to each slope sampling point may be obtained through the step S122, and then the coherence value corresponding to each slope sampling point is compared. The slope sampling point corresponding to the minimum coherence value is the local event slope (\hat{p}ₓ,\hat{p}_{y}) at the central position of the three-dimensional sampling data cube.

S130: determining a coherence value at the central position of each three-dimensional sampling data cube according to the local event slope at the central position of each three-dimensional sampling data cube and a coherence calculation formula that is based on a variational principle, to obtain a seismic coherence cube of the to-be-processed area.

The inventor of the present application finds that the C2 algorithm has a poor calculation effect when facing the seismic data with the significant lateral amplitude variation. Therefore, based on the variational principle, the inventor introduces the adaptive standard trace on the basis of the C2 algorithm, to eliminate the impact of the lateral amplitude variation of the seismic data.

A specific reasoning process of introducing the adaptive standard trace in the C2 algorithm is as follows.

A standard trace in the C2 algorithm is defined as follows:

$$\overline{u} ( i ) = \frac{1}{N} {\sum }_{j = 1}^{N} u ( i , j ) ,$$

in the formula, ū(i) represents the standard trace, u represents the seismic data in the calculation window, N represents the total quantity of traces in the calculation window, i represents the index of the time sampling point, and j represents the index of the quantity of seismic traces in the calculation window.

In the embodiment, for a problem of the C2 algorithm, the present application introduces an adaptive coefficient to adjust the standard trace based on the variational principle, and the adaptive coefficient is introduced in the standard trace to obtain the adaptive standard trace.

The adaptive standard trace uₐ(i,j) is defined as follows: uₐ(i,j)=a(j)ū(i).

In the formula, a(j) is the adaptive coefficient.

Under the above situation, the least-squares error Q between the seismic data of the three-dimensional sampling data cube corresponding to each data sampling point and the adaptive standard trace may be represented through continuous integral, and a specific calculation formula is as follows:

Q=∫∫(u(t,x)−uₐ(t,x))²dtdx=∫∫(u(t,x)−a(x)ū(t))²dtdx; and
in the formula, Q represents the least-squares error, t represents a time coordinate, and x represents a space coordinate.

In the embodiment, to solve a minimum value of the least-squares error Q, it is needed to find a suitable function a(x). At this time, this problem is converted into a variational problem, and Qₐ(x,a(x)=∫(u(t,x)−uₐ(t,x))²)d.

According to the variational principle, Qₐ needs to satisfy the Euler-Lagrange equation:

$$\frac{\partial {Q}_{a} ( x , a ( x )}{\partial a ( x )} - \frac{d}{dx} ( \frac{\partial {Q}_{a} ( x , a ( x )}{\partial a ( x )} ) = 0.$$

By solving the above equation, the function a(x) can be obtained. A solution of the variational problem means that: in all possible forms of a(x), a form of a(x) satisfying the Euler-Lagrange equation will cause the functional Q to reach a global minimum value.

An expression of the function a(x) can be obtained through the above formula:

$$a ( x ) = \frac{\int \overline{u} ( t ) u ( t , x ) dt}{\int {\overline{u}}^{2} ( t ) dt} .$$

On the basis of solving the variational problem to obtain the function a(x), the embodiment performs discrete representation on the function a(x), to obtain the adaptive coefficient a(j), which is specifically as follows:

$$a ( j ) = \frac{{Σ}_{i}^{M} \overline{u} ( i ) u ( i , j )}{{Σ}_{i}^{M} {\overline{u} ( i )}^{2}} .$$

At this time, the discretely represented adaptive coefficient is substituted into the least-squares error Q for discrete representation to be represented as:

$$Q = {Σ}_{i = 1}^{M} {{Σ}_{j = 1}^{N} [ u ( i , j ) - a ( j ) \overline{u} ( i ) ]}^{2} .$$

Normalization is performed on a discretely represented least-squares error, and the coherence calculation formula based on the variational principle may be obtained after the normalization. A specific calculation formula is as follows:

$${C}_{v} = \frac{{Σ}_{i = 1}^{M} {{Σ}_{j = 1}^{N} [ u ( i , j ) - a ( j ) \overline{u} ( i ) ]}^{2}}{{Σ}_{i = 1}^{M} {{Σ}_{j = 1}^{N} [ u ( i , j ) ]}^{2}} .$$

In the embodiment, after the local event slope (\hat{p}ₓ,\hat{p}_{y}) is obtained through steps S121 to S123, the local event slope is substituted into the normalized coherence calculation formula, to obtain a coherence value based on the local event slope. A specific calculation formula, that is, the coherence calculation formula, is as follows:

$${C}_{v} ( t , {\hat{p}}_{x} , {\hat{p}}_{y} ) = \frac{{Σ}_{i = 1}^{M} {{Σ}_{j = 1}^{N} [ u ( t + i Δ t - {\hat{p}}_{x} x - {\hat{p}}_{y} y , j ) - a ( j ) \overline{u} ( t + i Δ t - {\hat{p}}_{x} x - {\hat{p}}_{y} y ) ]}^{2}}{{Σ}_{i = 1}^{M} {{Σ}_{j = 1}^{N} [ u ( t + i Δ t - {\hat{p}}_{x} x - {\hat{p}}_{y} y , j ) ]}^{2}} ;$$

and
in the formula: Cᵥ represents the coherence value based on the variational principle, u represents the three-dimensional sampling data cube extracted in step S110, t represents sampling time at the central position of the three-dimensional sampling data cube, Δt is a time sampling interval, (\hat{p}ₓ,\hat{p}_{y}) represents the local event slope that is at the central position of the three-dimensional sampling data cube and that is obtained in step S120, M represents a quantity of time samples of the three-dimensional sampling data cube, i represents an index of a time sampling point, N represents a total quantity of traces of the three-dimensional sampling data cube, j represents an index of the quantity of traces, x and y represent space coordinates of a seismic trace corresponding to the central position of the three-dimensional sampling data cube, ū represents an average of all traces of the three-dimensional sampling data cube along a space direction,

$$\overline{u} ( i ) = \frac{1}{N} {Σ}_{j = 1}^{N} u ( i , j ) ,$$

a(j) represents an adaptive coefficient based on the variational principle, and

$$a ( j ) = \frac{{Σ}_{i}^{M} \overline{u} ( i ) u ( i , j )}{{Σ}_{i}^{M} {\overline{u}}^{2} ( i )} .$$

Therefore, in a specific embodiment of the present application, by using the above coherence calculation formula based on the variational principle, according to the local event slope at the central position of each three-dimensional sampling data cube, the least-squares error between the adaptive standard trace and each seismic trace in the calculation window can be calculated, and the coherence value at the central position of each three-dimensional sampling data cube can be determined, thereby obtaining the seismic coherence cube of the to-be-processed area.

According to the method for calculating a seismic coherence cube provided in the embodiment of the present application, based on the variational principle, by introducing the adaptive standard trace, the calculation formula of the C2 algorithm is improved. This method can not only process a problem of the lateral amplitude variation of the seismic data but also have the resolution of the C3 algorithm while maintaining the efficiency of the C2 algorithm during calculation, thereby significantly improving a distinguishing capability for faults, planes of unconformity, and other discontinuities.

The following is a comparison of seismic coherence cube calculation results obtained for different three-dimensional post-stack seismic data cubes by using the C2 algorithm, the C3 algorithm, and the method for calculating a coherence cube provided in the embodiment of the present application.

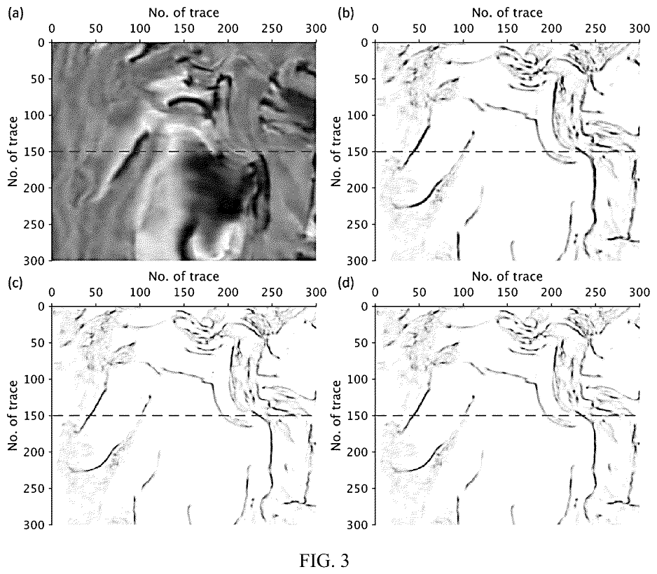

As shown in FIG. 3, FIG. 3-(a) is a horizontal slice of a three-dimensional post-stack seismic data cube A at a certain time position; FIG. 3-(b) shows a result by using the C2 algorithm; FIG. 3-(c) shows a result by using the C3 algorithm; and FIG. 3-(d) shows a result by using the coherence calculation formula based on the variational principle.

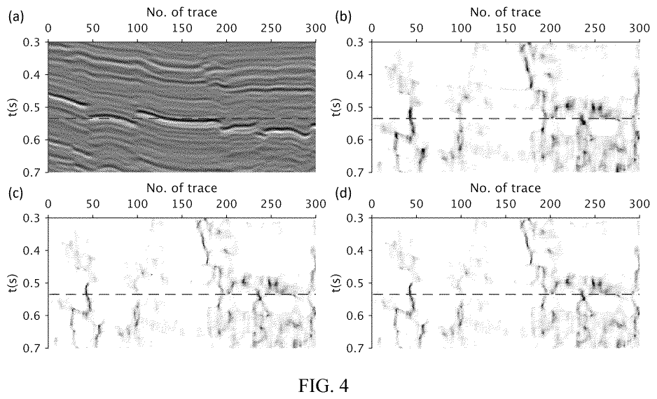

As shown in FIG. 4, FIG. 4-(a) is a vertical slice of a three-dimensional post-stack seismic data cube A at a certain space position; FIG. 4-(b) shows a result by using the C2 algorithm; FIG. 4-(c) shows a result by using the C3 algorithm; and FIG. 4-(d) shows a result by using the coherence calculation formula based on the variational principle.

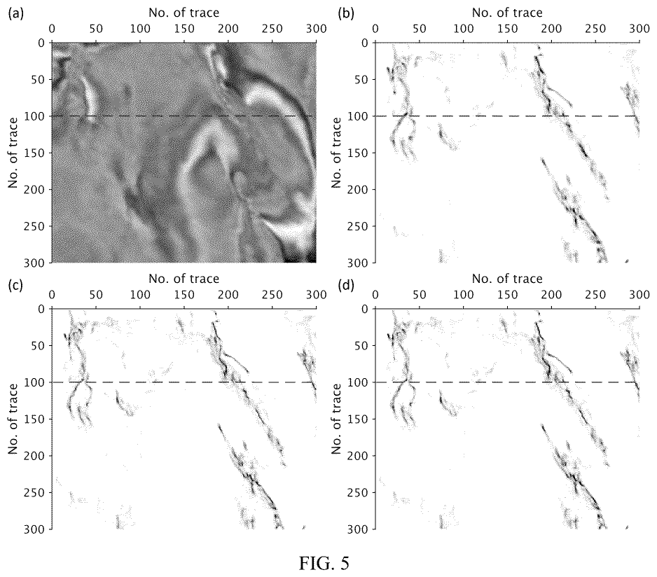

As shown in FIG. 5, FIG. 5-(a) is a horizontal slice of a three-dimensional post-stack seismic data cube B at a certain time position; FIG. 5-(b) shows a result by using the C2 algorithm; FIG. 5-(c) shows a result by using the C3 algorithm; and FIG. 5-(d) shows a result by using the coherence calculation formula based on the variational principle.

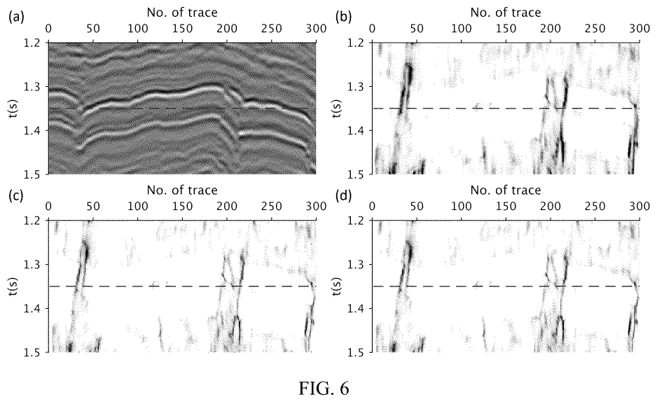

As shown in FIG. 6, FIG. 6-(a) is a vertical slice of a three-dimensional post-stack seismic data cube B at a certain space position; FIG. 6-(b) shows a result by using the C2 algorithm; FIG. 6-(c) shows a result by using the C3 algorithm; and FIG. 6-(d) shows a result by using the coherence calculation formula based on the variational principle.

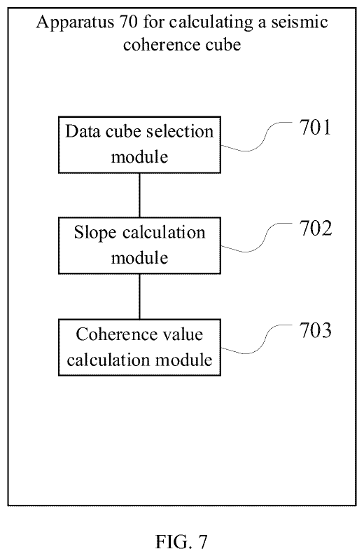

FIG. 7 is a schematic structural diagram of an apparatus for calculating a seismic coherence cube according to an embodiment of the present application. As shown in FIG. 7, the apparatus 70 for calculating a seismic coherence cube provided in the embodiment includes:
a data cube selection module 701, configured to sequentially extract three-dimensional sampling data cubes from a three-dimensional post-stack seismic data cube of a to-be-processed area according to a preset calculation window by using a single data sampling point as a center;
a slope calculation module 702, configured to determine a local event slope at a central position of each three-dimensional sampling data cube by using a direct search method; and
a coherence value calculation module 703, configured to determine a coherence value at the central position of each three-dimensional sampling data cube according to the local event slope at the central position of each three-dimensional sampling data cube and a coherence calculation formula that is based on a variational principle, to obtain a seismic coherence cube of the to-be-processed area, where
the coherence calculation formula that is based on the variational principle is as follows:

$${C}_{v} ( t , {\hat{p}}_{x} , {\hat{p}}_{y} ) = \frac{{Σ}_{i = 1}^{M} {{Σ}_{j = 1}^{N} [ u ( t + i Δ t - {\hat{p}}_{x} x - {\hat{p}}_{y} y , j ) - a ( j ) \overline{u} ( t + i Δ t - {\hat{p}}_{x} x - {\hat{p}}_{y} y ) ]}^{2}}{{Σ}_{i = 1}^{M} {{Σ}_{j = 1}^{N} [ u ( t + i Δ t - {\hat{p}}_{x} x - {\hat{p}}_{y} y , j ) ]}^{2}} ;$$

and
in the formula: Cᵥ represents the coherence value based on the variational principle, u represents the three-dimensional sampling data cube, t represents sampling time at the central position of the three-dimensional sampling data cube, Δt is a time sampling interval, (\hat{p}ₓ,\hat{p}_{y}) represents the local event slope at the central position of the three-dimensional sampling data cube, M represents a quantity of time samples of the three-dimensional sampling data cube, i represents an index of a time sampling point, N represents a total quantity of traces of the three-dimensional sampling data cube, j represents an index of the quantity of traces, x and y represent space coordinates of a seismic trace corresponding to the central position of the three-dimensional sampling data cube, ū represents an average of all traces of the three-dimensional sampling data cube along a space direction,

$$\overline{u} ( i ) = \frac{1}{N} {Σ}_{j = 1}^{N} u ( i , j ) ,$$

a(j) represents an adaptive coefficient based on the variational principle, and

$$a ( j ) = \frac{{Σ}_{i}^{M} \overline{u} ( i ) u ( i , j )}{{Σ}_{i}^{M} {\overline{u}}^{2} ( i )} .$$

In a possible implementation, the slope calculation module 702 may include a slope sampling point determination unit, a slope sampling point coherence value calculation unit, and a slope value determination unit.

The slope sampling point determination unit is configured to determine a plurality of slope sampling points of the local event slope according to value ranges and sampling intervals of a preset local event slope in a first direction and a second direction;
the slope sampling point coherence value calculation unit is configured to calculate a coherence value corresponding to each slope sampling point at the central position of each three-dimensional sampling data cube by using a coherence calculation formula that is based on multi-trace semblance; and

the slope value determination unit is configured to select, at the central position of each three-dimensional sampling data cube, a local event slope of a slope sampling point corresponding to a minimum coherence value as the local event slope at the central position of each three-dimensional sampling data cube.

In a possible implementation, the calculation window is a sampling range that uses the single data sampling point as the center and that is formed by a preset quantity of seismic traces and a preset length of time sampling points that surround the single data sampling point.

In a possible implementation, a quantity of seismic traces in the calculation window is 3, 5, or 9.

The apparatus for calculating a seismic coherence cube provided in the embodiment may execute the method provided by the above method embodiment, and an implementation principle and technical effect thereof are similar, which are not described in detail herein.

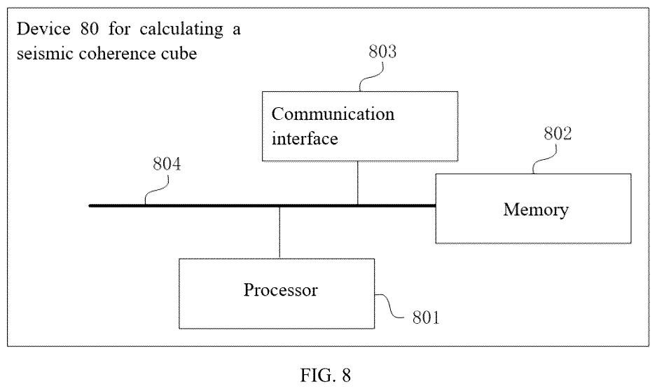

FIG. 8 is a schematic structural diagram of a device for calculating a seismic coherence cube according to an embodiment of the present application. As shown in FIG. 8, the device 80 for calculating a seismic coherence cube provided in the embodiment includes: at least one processor 801 and a memory 802. Optionally, the device 80 further includes a communication component 803. The processor 801, the memory 802, and the communication component 803 are connected through a bus 804.

During a specific implementation, the at least one processor 801 executes a computer executable instruction stored in the memory 802, to enable the at least one processor 801 to execute the above method.

A specific implementation process of the processor 801 may refer to the above method embodiment, and an implementation principle and technical effect thereof are similar, which are not described in detail again herein.

In the above embodiment, it should be understood that the processor may be a central processing unit (CPU), or may be another general-purpose processor, a digital signal processor (DSP), an application specific integrated circuit (ASIC), or the like. The general-purpose processor may be a microprocessor or the processor may also be any conventional processor or the like. Steps of the method disclosed with reference to the present invention may be directly executed and completed by a hardware processor, or may be executed and completed by using a combination of hardware and software modules in the processor.

The memory may include a high-speed random access memory (RAM) or a non-volatile memory (NVM), for example, at least one disk memory.

The bus may be an industry standard architecture (ISA) bus, a peripheral component (PCI) bus, an extended industry standard architecture (EISA) bus, or the like. The bus may be classified into an address bus, a data bus, a control bus, and the like. For ease of representation, the buses in the accompanying drawings of the present application are not limited to only one bus or one type of bus.

An embodiment of the present application further provides a computer program product, including a computer program, and when executed by a processor, the computer program executes the above method for calculating a seismic coherence cube.

The present application further provides a computer-readable storage medium, where the computer-readable storage medium stores a computer executable instruction, and when executing the computer executable instruction, a processor implements the above method for calculating a seismic coherence cube.

The above readable storage medium may be implemented by any type of volatile or non-volatile storage device or a combination thereof, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc. The readable storage medium may be any available medium accessible to a general-purpose or a dedicated computer.

For example, the readable storage medium is coupled to the processor, so that the processor can read information from the readable storage medium and write information to the readable storage medium. Certainly, the readable storage medium may alternatively be a component of the processor. The processor and the readable storage medium may be located in an application specific integrated circuit (ASIC). Certainly, the processor and the readable storage medium may exist in a device as discrete components.

Division into the units is merely logical function division and may be another division during actual implementation. For example, a plurality of units or components may be combined or integrated into another system some features may be ignored or not performed. In addition, the displayed or discussed mutual couplings or direct couplings or communications connections may be implemented by using some interfaces. The indirect couplings or communications connections between apparatuses or units may be implemented in electrical, mechanical, or other forms.

The units described as separate parts may or may not be physically separate, and parts displayed as units may or may not be physical units, that is, may be located in one position, or may be distributed on a plurality of network units. Some or all of the units may be selected based on actual requirements to achieve the objectives of the solutions of embodiments.

In addition, functional units in the embodiments of the present invention may be integrated into one processing unit, or each of the units may exist alone physically, or two or more units may be integrated into one unit.

When functions are implemented in a form of a software function unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The computer software product is stored in a storage medium, and includes several instructions for instructing a computer device (which may be a personal computer, a server, or a network device) to perform all or some of the steps of the methods described in the embodiments of the present invention. The foregoing storage medium includes any medium that can store program code, such as a USB flash drive, a removable hard disk, a read-only memory (ROM), a random access memory (RAM), a magnetic disk, or an optical disc.

Those of ordinary skill in the art may understand that all or some of the steps of the method embodiments may be implemented by a program instructing related hardware. The program may be stored in a computer-readable storage medium. When the program is executed, the steps of the method embodiments are performed. The foregoing storage medium includes various media that can store program code, such as a ROM, a RAM, a magnetic disk, or an optical disc.

Finally, it should be noted that a person skilled in the art can easily figure out another implementation solution of the present invention after considering this specification and practicing the invention that is disclosed herein. The present invention is intended to cover any variations, uses, or adaptive changes of the present invention. These variations, uses, or adaptive changes follow the general principles of the present invention, include common knowledge or customary technical means in the art that are not disclosed in the present invention, are not limited to the accurate structures that have been described in the above description and shown in the accompanying drawings, and may be modified and changed without departing from the scope of the present invention. The scope of the present invention is limited by the appended claims only.

What is claimed is:

1. A method for calculating a seismic coherence cube, comprising:
sequentially extracting three-dimensional sampling data cubes from a three-dimensional post-stack seismic data cube of a to-be-processed area according to a preset calculation window by using a single data sampling point as a center;
determining a local event slope at a central position of each three-dimensional sampling data cube by using a direct search method; and
determining a coherence value at the central position of each three-dimensional sampling data cube according to the local event slope at the central position of each three-dimensional sampling data cube and a coherence calculation formula that is based on a variational principle, to obtain a seismic coherence cube of the to-be-processed area, wherein
the coherence calculation formula that is based on the variational principle is as follows:
$${C}_{v} ( t , {\hat{p}}_{x} , {\hat{p}}_{y} ) = \frac{{Σ}_{i = 1}^{M} {{Σ}_{j = 1}^{N} [ u ( t + i Δ t - {\hat{p}}_{x} x - {\hat{p}}_{y} y , j ) - a ( j ) \overline{u} ( t + i Δ t - {\hat{p}}_{x} x - {\hat{p}}_{y} y ) ]}^{2}}{{Σ}_{i = 1}^{M} {{Σ}_{j = 1}^{N} [ u ( t + i Δ t - {\hat{p}}_{x} x - {\hat{p}}_{y} y , j ) ]}^{2}} ;$$
and
in the formula: Cᵥ represents the coherence value based on the variational principle, u represents the three-dimensional sampling data cube, t represents sampling time at the central position of the three-dimensional sampling data cube, Δt is a time sampling interval, (\hat{p}ₓ,\hat{p}_{y}) represents the local event slope at the central position of the three-dimensional sampling data cube, M represents a quantity of time samples of the three-dimensional sampling data cube, i represents an index of a time sampling point, N represents a total quantity of traces of the three-dimensional sampling data cube, j represents an index of the quantity of traces, x and y represent space coordinates of a seismic trace corresponding to the central position of the three-dimensional sampling data cube, ū represents an average of all traces of the three-dimensional sampling data cube along a space direction,
$$\overline{u} ( i ) = \frac{1}{N} {Σ}_{j = 1}^{N} u ( i , j ) ,$$
a(j) represents an adaptive coefficient based on the variational principle, and
$$a ( j ) = \frac{{Σ}_{i}^{M} \overline{u} ( i ) u ( i , j )}{{Σ}_{i}^{M} {\overline{u}}^{2} ( i )} .$$

2. The method for calculating a seismic coherence cube according to claim 1, wherein a process of determining a local event slope at a central position of each three-dimensional sampling data cube by using a direct search method comprises:
determining a plurality of slope sampling points according to value ranges and sampling intervals of a preset local event slope in a first direction and a second direction;
calculating a coherence value corresponding to each slope sampling point at the central position of each three-dimensional sampling data cube by using a coherence calculation formula that is based on multi-trace semblance; and
selecting, at the central position of each three-dimensional sampling data cube, a local event slope of a slope sampling point corresponding to a minimum coherence value as the local event slope at the central position of each three-dimensional sampling data cube.

3. The method for calculating a seismic coherence cube according to claim 1, wherein the calculation window is a sampling range that uses the single data sampling point as the center and that is formed by a preset quantity of seismic traces and a preset length of time sampling points that surround the single data sampling point.

4. The method for calculating a seismic coherence cube according to claim 3, wherein a quantity of seismic traces in the calculation window is 3, 5, or 9.

5. An apparatus for calculating a seismic coherence cube, comprising:
a data cube selection module, configured to sequentially extract three-dimensional sampling data cubes from a three-dimensional post-stack seismic data cube of a to-be-processed area according to a preset calculation window by using a single data sampling point as a center;
a slope calculation module, configured to determine a local event slope at a central position of each three-dimensional sampling data cube by using a direct search method; and
a coherence value calculation module, configured to determine a coherence value at the central position of each three-dimensional sampling data cube according to the local event slope at the central position of each three-dimensional sampling data cube and a coherence calculation formula that is based on a variational principle, to obtain a seismic coherence cube of the to-be-processed area, wherein
the coherence calculation formula that is based on the variational principle is as follows:
$${C}_{v} ( t , {\hat{p}}_{x} , {\hat{p}}_{y} ) = \frac{{Σ}_{i = 1}^{M} {{Σ}_{j = 1}^{N} [ u ( t + i Δ t - {\hat{p}}_{x} x - {\hat{p}}_{y} y , j ) - a ( j ) \overline{u} ( t + i Δ t - {\hat{p}}_{x} x - {\hat{p}}_{y} y ) ]}^{2}}{{Σ}_{i = 1}^{M} {{Σ}_{j = 1}^{N} [ u ( t + i Δ t - {\hat{p}}_{x} x - {\hat{p}}_{y} y , j ) ]}^{2}}$$
and
in the formula: Cᵥ represents the coherence value based on the variational principle, u represents the three-dimensional sampling data cube, t represents sampling time at the central position of the three-dimensional sampling data cube, Δt is a time sampling interval, (\hat{p}ₓ,\hat{p}_{y}) represents the local event slope at the central position of the three-dimensional sampling data cube, M represents a quantity of time samples of the three-dimensional sampling data cube, i represents an index of a time sampling point, N represents a total quantity of traces of the three-dimensional sampling data cube, j represents an index of the quantity of traces, x and y represent space coordinates of a seismic trace corresponding to the central position of the three-dimensional sampling data cube, ū represents an average of all traces of the three-dimensional sampling data cube along a space direction,
$$\overline{u} ( i ) = \frac{1}{N} {Σ}_{j = 1}^{N} u ( i , j ) ,$$
a(j) represents an adaptive coefficient based on the variational principle, and
$$a ( j ) = \frac{{Σ}_{i}^{M} \overline{u} ( i ) u ( i , j )}{{Σ}_{i}^{M} {\overline{u}}^{2} ( i )} .$$

6. The apparatus for calculating a seismic coherence cube according to claim 5, wherein the slope calculation module comprises:
a slope sampling point determination unit, configured to determine a plurality of slope sampling points according to value ranges and sampling intervals of a preset local event slope in a first direction and a second direction;
a slope sampling point coherence value calculation unit, configured to calculate a coherence value corresponding to each slope sampling point at the central position of each three-dimensional sampling data cube by using a coherence calculation formula that is based on multi-trace semblance; and
a slope value determination unit, configured to select, at the central position of each three-dimensional sampling data cube, a local event slope of a slope sampling point corresponding to a minimum coherence value as the local event slope at the central position of each three-dimensional sampling data cube.

7. An electronic device, comprising: a memory and a processor, wherein
the memory stores a computer executable instruction; and
the processor executes the computer executable instruction stored in the memory, to enable the processor to execute the method for calculating a seismic coherence cube according to claim 1.

8. A computer-readable storage medium, wherein the computer-readable storage medium stores a computer executable instruction, and when executed by a processor, the computer executable instruction is used to implement the method for calculating a seismic coherence cube according to claim 1.
